(19) United States
(12) Patent Application Publication
(10) Pub. No.: US 2024/0424436 A1
(43) Pub. Date: Dec. 26, 2024

(54) PASSIVE DEVICE FOR CAPTURING MICROPARTICLES IN SUSPENSION IN THE AIR

(71) Applicants: TRAPAPART, STRASBOURG (FR); CENTRE NATIONAL DE LA RECHERCHE SCIENTIFIQUE, PARIS CEDEX 16 (FR); UNIVERSITE DE STRASBOURG, STRASBOURG CEDEX (FR)

(72) Inventors: Charlotte PHAM, Strasbourg (FR); Christophe VIEVILLE, Saverne (FR); Nicolas HERTEL, Saint-Remy lès Chevreuse (FR); Housseinou BA, Strasbourg (FR); Jean-Mario NHUT, Plobsheim (FR); Cuong PHAM-HUU, Strasbourg (FR); Fabrice VIGNERON, Strasbourg (FR); Lai TRUONG-PHUOC, Strasbourg (FR); Tuan-Hoang TRINH, Strasbourg (FR)

(21) Appl. No.: 18/698,970

(22) PCT Filed: Oct. 13, 2022
(86) PCT No.: PCT/IB2022/059815

§ 371 Date: Apr. 5, 2024

(30) Foreign Application Priority Data
Oct. 14, 2021 (FR) 2110910
Dec. 14, 2021 (FR) 2113509
Aug. 31, 2022 (FR) 2208715

(51) Int. Cl. B01D 46/00; B01D 46/66

(52) U.S. Cl. CPC B01D 46/0035; B01D 46/0001; B01D 46/66

(57) ABSTRACT

The present application is directed to a device which serves to capture microparticles in suspension in the air and which has no active means of ventilation and no means of electrical energy supply. The device comprises a structured support traversed by a large number of openings with a minimum dimension of between 1 millimetre and 15 mm, the structured support having a void fraction of greater than 80%, the structured support being coated with a medium for capturing the microparticles in suspension in a flow of air, the medium being chosen from among: vegetable oils, mineral oils, synthetic or semi-synthetic oils, water-soluble lubricants, silicone oils, animal fat, the structured support coated with the capturing medium being configured to be traversed by a flow of air at a linear speed of between 0.1 and 5 m/s without causing a pressure drop of more than 300 Pa, preferably without causing a pressure drop of more than 250 Pa. The present application is also directed to a method for capturing microparticles in suspension in the air and to the use of the device, more particularly in an underground network for transporting passengers by rail.

### CROSS-REFERENCE TO RELATED APPLICATIONS

The present application is a National Stage Application of PCT International Application No. PCT/IB2022/059815 (filed on Oct. 13, 2022), under 35 U.S.C. § 371, which claims priority to French Patent Application Nos. FR 2110910 (filed on Oct. 14, 2021), FR 2113509 (filed on Dec. 14, 2021), FR 2208715 (filed on Aug. 31, 2022), which are each hereby incorporated by reference in their complete respective entireties.

### TECHNICAL FIELD OF THE INVENTION

The present invention relates to the field of air purification devices and processes. More particularly, it concerns devices and processes making it possible to capture a significant portion of the microparticles contained in ambient air. The invention finds a particularly advantageous application in the purification of ambient air in underground circulation and transport networks. The present invention relates to a device provided with a structured support for capturing microparticles in suspension in the air without active means of mechanical ventilation and means of supplying electrical energy. The present invention also relates to a method of capturing microparticles by a device which is the object of the invention.

### PRIOR ART

Particle pollution of the air in urban and peri-urban environments from various sources causes significant public health problems and is the cause of respiratory diseases for exposed populations and additional costs for health organizations.

In its 2018 report, the European Environment Agency indicates that excessively high concentrations of particles in suspension (or “PM”, abbreviated from the English “Particulate matter”) were responsible for around 422,000 premature deaths annually in 41 European countries, including around 391,000 in the 28 states of the European Union. Thus, the provision of air with a lower concentration of suspended particles is a public health issue.

To reduce the concentration of particles in suspension in the air in a closed space where this concentration is particularly high, an effective ventilation system can be implemented. This solution, mainly implemented in underground networks, consists of renewing the air in the underground network with air less loaded with particles coming from the outside, the underground air being released outside without any treatment. This solution has the disadvantage of not eliminating pollutants, but only moving them from the inside to the outside, which increases outdoor air pollution. In addition, this solution is not suitable for implementation outside an enclosed space, for example in the open air.

Other systems currently being implemented aim to capture and retain microparticles in suspension in the air. Among the most common technologies we can cite the use of filter media with pores of an appropriate size to retain particles, electrostatic precipitation of microparticles by application of an electric field or the absorption of microparticles in a flow of liquid circulated through the system.

These technologies require a power supply for their proper functioning, which prevents the installation of such systems in places without connection to the electricity network or in places where changing a battery would be impractical.

In addition, these technologies require for their proper functioning a directed air flow which circulates from an air inlet where a flow of air to be purified enters towards an air outlet from which a flow of air relieved of part of its particles in suspension is released. The directed nature of an air cleaning system means that the air cleaning system ceases to function properly in the absence of air flow directed in the intended direction. This oriented nature can also imply a risk of release, that is to say a risk that the particles captured by the air purification system will be released in the event of a reversal of the air flow. In order to guarantee a constant and directed air flow, the air flow is usually generated by a fan or any other equivalent mechanical means, which has the disadvantage of complicating the installation by the addition of moving parts. In particular, systems using a filtering medium, that is to say whose pore sizes retain particles in suspension, require a sufficiently powerful air flow to compensate for the significant pressure drop caused by the filter.

### OBJECTS OF THE INVENTION

It should be recalled that a microparticle is a particle whose size is between 0.1 μm and 100 μm. In the context of the invention, the term “particles in suspension” designates microparticles suspended in the air and particularly microparticles of size less than or equal to 10 μm in diameter, also called PM10, as well as microparticles of sizes less than 2.5 μm, also called PM2.5 and less than 1 μm, also called PM1.

The applicant has set itself the objective of reducing the concentration of microparticles in suspension in the air of collective urban spaces, in particular near road or rail transport infrastructures and particularly for application in an underground transport network, which can notably be road or rail.

For these applications, the applicant sought a device which combines good ease of maintenance, a certain robustness, an ability to operate without electrical power and a very low pressure drop. As none of the solutions of the prior art meets all of these criteria, the applicant has developed the device and the method which are the objects of the present invention.

The present invention aims to remedy all or part of the disadvantages of the solutions of the prior art.

To this end, according to a first object, the present invention aims at a device for capturing microparticles in suspension in the air which has the following characteristics:
the device has no active means of ventilation and no means of electrical energy supply,
the device comprises a structured support traversed by a large number of

openings with a minimum dimension comprised between 1 millimeter and 15 millimeters, said structured support having a void ratio of greater than 80%, preferably greater than 85%, preferably greater than 90%, very preferably of the order of 95%,
the structured support being coated with a medium for capturing microparticles in suspension in an air flow chosen from: vegetable oils, mineral oils, synthetic and semi-synthetic oils, water-soluble lubricants, silicone oils, animal fats, used alone or in mixture,
the structured support coated with said capture medium being configured to be traversed by an air flow at a linear speed between 0.1 and 5 m/s without causing a pressure drop greater than 300 Pa, preferably without causing a pressure drop greater than 250 Pa.

For the purposes of the invention, the minimum dimension of an opening passing through the structured support corresponds to the diameter of the opening measured at its narrowest point. In other words, a minimum dimension of an opening of 1 millimeter means that a spherical particle of 1 millimeter in diameter can pass through said opening without being blocked.

Preferably, the average dimension of the openings is of the order of 5 millimeters. For example, the average size of the openings is comprised between 3 and 10 millimeters.

These openings are present in the structured support of a device according to the invention “in large numbers”, and a minimum number can be set, more or less arbitrarily, at around a thousand. For example, the structured support has on average at least one opening per square centimeter, or at least 4 openings per square centimeter, or at least 16 openings per square centimeter.

For the purposes of the invention, the void ratio corresponds to the ratio between the volume of the structured support which is empty and the volume of the space delimited by the structured support which is occupied by solid material.

The structured support can for example be a metallic cross-shaped support having large openings or a polyester mesh forming large hexagonal openings. Any structured support according to the invention comprises large and numerous openings of substantially identical sizes, that is to say in the same order of magnitude of size. The structured support does not have a filtration role but rather a support role for the capture medium. Indeed, the diameter of the openings of the structured support according to the invention, of the order of a millimeter, is much greater than the diameter of the microparticles captured by means of the device, of the order of a micrometer or a few tens of micrometers. These provisions contribute to the very low pressure drop of the structured support.

The capture medium coated on the structured support ensures the capture of the microparticles either by a mechanism of sticking of the microparticles to the medium, or by a mechanism of partial penetration of the microparticles into the medium, or even by a combination of these mechanisms. Thanks to these provisions, a portion of the microparticles present in an air flow passing through the device are captured by the capture medium. It is clearly understood that the device does not require for its proper functioning that the air flow circulates across the device in a predetermined direction, as long as a contact between the air flow and the capture medium takes place. In this way, the device is not oriented, which is particularly advantageous for positioning the device in a location where the direction of the air flows is likely to vary. The direction of an air flow is particularly likely to vary when the device is positioned outdoors, depending on the direction of the wind or when it is positioned near a road or rail transport route, depending on the direction of vehicle passage.

Furthermore, given that the microparticles do not accumulate only on one side of the structured support and that said microparticles are stuck and/or penetrate at least partially into the medium, the device is unlikely to release microparticles that have already been captured into the air, in the event of a change in direction of the air flow passing through the device.

It is also understood that the device which is the subject of the invention does not require, for its proper functioning, active ventilation means, such as fan blades, nor an electrical energy supply, no component of the device requiring such a power supply.

This greatly facilitates its installation in a desired location, which may be a place difficult to access, for example in a railway tunnel, where carrying out specific electrical installation work would represent an unacceptable cost, and where the use of photovoltaic panels is not possible due to lack of light.

Over time, the accumulation of microparticles in the medium will be likely to lower the capture efficiency of the device which is the object of the invention. Thus, at regular intervals, it will be useful to replace the saturated capture medium with fresh capture medium (new or recycled). Preferably, the capture medium is stripped of the structured support so that the structured support can be recoated and used again.

In embodiments, the structured support is formed of a non-porous material.

In the context of the invention, we distinguish between “pores” and “openings”. Pores are cavities of small dimensions, typically less than 10 microns, and which do not necessarily pass through. In contrast, openings are through, and their size is between 1 mm and 15 mm. Thus, the porosity of a non-porous material according to the invention, expressed as a percentage of voids left by the pores as defined above, relative to the remainder of the volume occupied by the structured support is preferably less than 1%, very preferably less than 0.1%.

Thanks to these provisions, the capture medium is not absorbed by the material constituting the structured support. These provisions make it possible to prevent a reduction in the efficiency of particle capture by the structured support coated with capture medium which would be less if a significant part of the capture medium penetrated into the pores of the material constituting the structured support.

In embodiments, the structured support is arranged substantially vertically, and the capture medium is a liquid material at ambient temperatures of use, held by surface tension on the structured support.

For example, the structured support is inclined at an angle less than or equal to 25°, preferably less than 15° relative to the vertical; such a slight inclination is understood here as a “substantially vertical” arrangement.

In embodiments, the capture medium is a vegetable oil. Preferably, the vegetable oil is chosen from compositions containing few unsaturated and polyunsaturated fatty acids or containing a high antioxidant content (for example vitamin E or polyphenols) which gives them good stability over time. For example, olive oil, apricot kernel oil, jojoba oil, sweet almond oil, castor oil, coconut oil, shea oil, hazelnut oil, plum oil, sea buckthorn oil, argan oil, avocado oil, hemp oil, macadamia oil, oleic sunflower oil or palm oil are preferred. Other vegetable oils can also be used in poorly lit environments or when the ambient temperature is sufficiently low (for example in winter).

In embodiments, the capture medium is a vegetable oil having an added antioxidant compound. The stability of the vegetable oil is thus extended by the addition of antioxidants.

In embodiments, the capture medium comprises a mineral oil, such as paraffin oil, or even a silicone oil.

In embodiments, the capture medium comprises a silicone oil, for example chosen from polydimethylsiloxanes, pure or modified by polyethers. Silicone-polyethers copolymers have the advantage of being water-soluble.

In embodiments, the capture medium comprises a synthetic or semi-synthetic oil, for example based on polymers.

In embodiments, the capture medium comprises a water-soluble lubricant, for example in the form of an emulsion or microemulsion formulated based on polyesters.

In embodiments, the structured support includes a woven textile. According to a particular embodiment, the textile is woven from polyester fibers.

In embodiments, the structured support is a cellular foam whose cells are open and the size of which is between 2 mm and 10 mm. These cellular structures can be flexible, typically made of polyurethane or rigid, for example made of metal or ceramic based on alumina or a mixture of metal oxides.

In embodiments, the structured support comprises a plurality of plates assembled together. Said plates are substantially flat pieces, crossed by holes with a minimum diameter of between approximately 1 mm and 15 mm and coated with capture medium. Said plates can for example be superimposed or even joined at one of their ends and inclined together in a “V” or “W” arrangement. It is emphasized that the structured support coated with capture medium must as a whole, even when it is an assembly, present a low pressure drop according to the limits set by the invention. For example, the structured support as a whole is configured to be traversed by an air flow at a linear speed of 5 m/s without causing a pressure drop greater than 300 Pa, preferably without causing a pressure drop greater than 250 Pa.

In embodiments, the structured support includes a metal structure. More particularly, the structured support may be a metallic structure made of expanded metal, a metal plate obtained by stamping or an expanded and stamped metal plate.

In embodiments, the structured support is an assembly of several metal plates. In embodiments, the structured support comprises a metal plate of expanded metal and corrugated by stamping interposed between two metal plates of expanded metal.

It should be recalled that an expanded metal plate is a metal plate which has been cut and then stretched. In other words, expanded metal is made by shearing a plate or coil of metal in a press, equipped with knives creating a metal mesh generally diamond-shaped, leaving voids surrounded by interconnected metal bars. Preferably, the metal constituting the metal plate is steel or aluminum. Aluminum is preferred because it is less heavy. Furthermore, it is not a known catalyst for the oxidation of vegetable oils, unlike iron.

In embodiments, the structured support includes an anodized metal structure.

Thanks to these provisions, the metal has increased roughness and more easily retains the coated medium on the structured support.

In embodiments, the structured support comprises a metallic honeycomb structure forming a pattern of polygonal cells, in particular hexagonal or rectangular. The metal constituting the walls of the cells is preferably aluminum.

In embodiments, the device which is the object of the invention comprises a box housing the structured support coated with capture medium. Preferably, the box has a thickness of less than 40 cm, preferably less than 30 cm and very preferably less than 25 cm. This low thickness allows installation in restricted spaces, in particular under the nose of a platform in a railway station.

In embodiments, the structured support comprises a multitude of layers superimposed and spaced from each other by a distance of at least 0.5 mm, preferably at least spaced by 1 mm, very preferably at least spaced by 5 mm.

According to a second aspect, the invention aims at the use of a device for capturing microparticles in suspension in the air according to the invention, implemented in an underground, in particular in a complex dedicated to collective rail transport, particularly in pedestrian passenger traffic areas, at the nose of a platform, at the mouth of a railway tunnel, in a railway tunnel in a braking zone, or even in a railway tunnel in an acceleration zone.

The use of a device which is the object of the invention in a network of railway tunnels intended for passenger transport is particularly useful because this enclosed environment sees a large number of travelers passing through who are exposed to a high concentration of microparticles generated by rail transport.

In embodiments, the microparticle capture device which is the object of the invention, placed in a railway tunnel, comprises a substantially planar structured support and said structured support is substantially parallel to the main axis of a rail sheltered by the tunnel railway.

In embodiments, the device according to the invention is positioned in a railway tunnel on a braking zone or on an acceleration zone, preferably on a braking zone.

A braking zone or an acceleration zone is defined as the zone located less than 5 meters from a section of rail along which the train brakes before arriving at the station or accelerates when leaving the station. The preferred areas are those less than 100 meters from the station mouth, and even more preferably less than 50 meters from the station mouth.

The placement of the device which is the object of the invention at the level of the braking zones which are the main zones of microparticle emissions in an underground rail transport network is favoured. For example, the device according to the invention is placed near the mouth of the station, on the side where the train enters the station, either on the wall of the tunnel, or on the vertical wall of the platform at the height of the bogies of the train.

In embodiments, the device according to the invention is positioned in the last meters of the tunnel before arrival at the station, as close as possible to the exterior rail and ideally opposite the braking system of a train when the train enters the station and positioned at a height corresponding to the height of the train's braking system or just above.

According to a third aspect, the present invention aims at a method for capturing microparticles in suspension in the air, which comprises:
the provision of a structured support traversed by a large number of openings of minimum dimension comprised between 1 millimeter and 15 millimeters, said structured support having a void ratio greater than 80%, preferably greater than 85%, preferably greater than 90%, very preferably of the order of 95%,
coating the structured support with a capture medium configured to capture by contact microparticles in suspension in an air flow chosen from: a vegetable oil, a mineral oil, a synthetic or semi-synthetic oil, a water-soluble lubricant, a silicone oil, and an animal fat, alone or in a mixture,
the structured support coated with capture medium being configured to be traversed by an air flow at a linear speed comprised between 0.1 m/s and 5 m/s without causing a pressure drop greater than 300 Pa, preferably without causing a pressure drop greater than 250 Pa and
bringing the structured support into contact with an air flow loaded with microparticles without active means of ventilation allowing the forced circulation of the air flow loaded with microparticles.

In embodiments, the method comprises:
a step of stripping at least part of the capture medium coated on the structured support and
a step of replacing the stripped capture medium by coating the structured support with a fresh capture medium.

In embodiments, the stripping step includes washing the structured support coated with capture medium with soapy water.

In embodiments, the stripping step comprises stripping the structured support coated with capture medium by a flow of pressurized air.

In embodiments, the stripping step comprises stripping the structured support coated with capture medium by a flow of pressurized water vapor.

In embodiments, the stripping step includes cryogenic cleaning.

The aims, advantages and particular characteristics of the method which is the object of the present invention being similar to those of the device which is the subject of the present invention, they are not recalled here.

### BRIEF DESCRIPTION OF THE FIGURES

Other advantages, aims and particular characteristics of the invention will emerge from the following non-limiting description of at least one particular embodiment of the device and the method which are the object of the present invention, with reference to the appended drawings, in which:

FIG. 1 represents, schematically, a first particular embodiment of the device which is the object of the present invention,

FIG. 2 represents a photograph of a structured support implemented in the first particular embodiment of the device which is the object of the present invention,

FIG. 3 represents a photograph of a structured support implemented in the first particular embodiment of the device which is the object of the present invention,

FIG. 4 represents a structured support implemented in a second particular embodiment of the device which is the object of the present invention,

FIG. 5 represents a photograph of a structured support implemented in a third particular embodiment of the device which is the object of the present invention,

FIG. 6 represents, schematically and in perspective, a particular embodiment of the device which is the object of the present invention which comprises a protective box,

FIG. 7 represents a photograph of a particular embodiment of the device which is the object of the present invention, installed under a platform in a railway station,

FIG. 8 represents, schematically and in the form of a flowchart, a succession of particular steps of the process which is the object of the present invention and

FIG. 9 represents, in graphic form, pressure drop values measured on devices object to the invention, as a function of the square of the air speed.

### DETAILED DESCRIPTION OF THE INVENTION

The present description is given on a non-limiting basis, each characteristic of an embodiment being able to be combined with any other characteristic of any other embodiment in an advantageous manner.

It is noted, from now on, that the schematic figures are not to scale. The figures representing a photograph are to scale but the scales between them may vary.

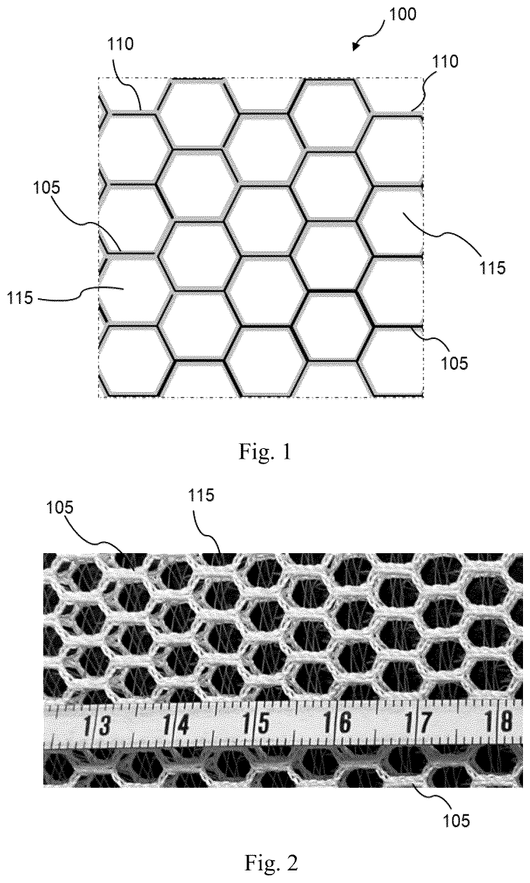

It can be seen in FIG. 1 a schematic view of an embodiment of the device 100 which is the object of the present invention. According to this particular embodiment, the device 100 for capturing microparticles comprises a structured support 105 formed of a network composed of hexagonal meshes connected together. Such a mesh network can be produced by weaving fibers. These fibers may be polyester fibers.

The structured support 105 is traversed by a large number of openings 115 with a minimum dimension greater than 1 millimeter and an average dimension of around 5 millimeters. We prefer not to exceed a maximum dimension of 15 mm, and preferably not to exceed a maximum dimension of 10 millimeters. The structured support 105 has a void ratio greater than 80%, preferably greater than 85%, preferably greater than 90%, very preferably of the order of 95%.

The structured support 105 is configured to have a very low pressure drop. In addition to the large size of the openings which leads to a slight obstacle to the circulation of an air flow through the structured support 105, care will be taken not to add other elements to the device 100, for example which would be likely to increase the overall pressure drop of the device beyond 300 Pa, or preferably beyond 250 Pa or preferably beyond 160 Pa. Thus, the structured support 105 coated with said capture medium is configured to be traversed by a flow of air with a linear speed of between 0.1 and 5 m/s without causing a pressure drop greater than 250 Pa. Preferably, the structured support 105 coated with said capture medium is configured to be traversed by an air flow of linear speed equal to 3 m/s, very preferably equal to 5 m/s without causing a pressure drop greater than 250 Pa. In embodiments, the structured support 105 coated with said capture medium is configured to be traversed by an air flow of linear speed equal to 3 m/s, very preferably equal to 5 m/s without causing a pressure drop greater than 160 Pa. In embodiments, the structured support 105 coated with said capture medium is configured to be traversed by an air flow of linear speed equal to 3 m/s, very preferably equal to 5 m/s without causing a pressure drop greater than 300 Pa.

In a particular embodiment, the structured support 105 coated with said capture medium is configured to be traversed by an air flow of linear speed equal to 2 m/s without causing a pressure drop greater than 25 Pa, or configured to be traversed by an air flow of linear speed of 5 m/s without causing a pressure drop greater than 156 Pa, or configured to be traversed by an air flow of linear speed of 0.1 m/s without causing a pressure drop greater than 0.06 Pa.

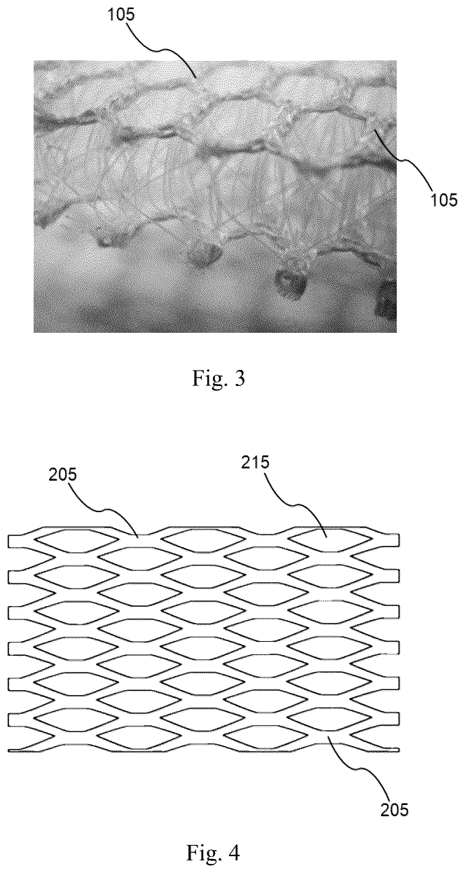

In embodiments, the structured support may be composed of several layers of materials superimposed on each other. For example, the structured support illustrated in FIGS. 2 and 3 is a woven support with a surface area of 0.045 m² and a thickness of 6 mm formed by three-dimensional weaving of polyester fibers. Weaving makes it possible to obtain two parallel layers comprising meshes with an average opening of 5 mm representing approximately 63% of the surface. The density of the woven support is 380 g/m². It has a void rate of around 95%. The Aerosleep® product marketed by the company QLEVR could, for example, be used as a structured support.

It is noted that the scale visible in the photograph in FIG. 2 is expressed in centimeters.

According to an essential characteristic of the invention, the structured support 105 is coated with a capture medium 110. This capture medium is advantageously chosen from: vegetable oils, silicone oils, mineral oils, synthetic or semi-synthetic oils, water-soluble lubricants and fats of animal origin, alone or in combination. Preferably, the capture medium 110 is a liquid held in place on the structured support by surface tension.

In embodiments, the vegetable oil is selected from olive oil, apricot oil, jojoba oil, sweet almond oil, castor oil, coconut oil, shea oil, hazelnut oil, plum oil, sea buckthorn oil, argan oil, avocado oil, macadamia hemp oil, oleic sunflower oil or palm oil.

In other embodiments, the mineral oil is a paraffin oil. In yet other embodiments, the animal fat is pork fat. In yet other embodiments, the water-soluble lubricant is an emulsion or microemulsion formulated on the basis of polyesters.

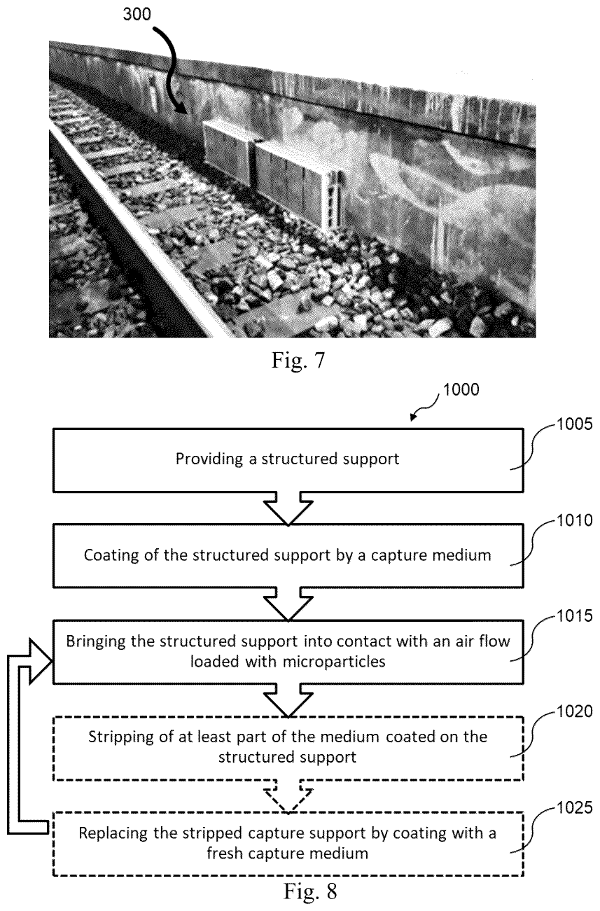

In a particular embodiment, the structured support 105 illustrated in FIGS. 2 and 3 is immersed in a bath of capture medium so that its entire surface is covered with this capture medium. The coated media is removed from the bath and then hung vertically for 5 hours so that excess capture medium drips off naturally. The support coated with capture medium thus obtained has a density of 590 g/m². Its void rate is close to 91%. The coated structured support thus obtained is ready for use, optionally after having been mounted in an appropriate protective box, and in particular of the type of those illustrated in FIGS. 6 and 7. Such structured supports coated with capture medium were tested by the applicant under different operating conditions. These tests and their results in terms of microparticle capture efficiency are presented at the end of this description.

It is observed, in FIG. 4, a schematic view of another embodiment of a structured support 205 which can be implemented in a device for capturing microparticles according to the invention. The structured support 205 is made of metallic material, for example steel or aluminum. Preferably, the metallic material is anodized.

The metallic structured support may comprise a single layer of expanded metal or several layers superimposed on each other. In one embodiment (not shown) the structured support comprises a metal plate of expanded metal corrugated by stamping interposed between two metal plates of expanded metal.

For example, to form this support, a first expanded aluminum sheet of 4 mm thickness is provided with open meshes having a large width of 16 mm and a small width of 8 mm. These openings represent a volume void rate of 88%. A second expanded sheet is then obtained by stamping a sheet similar to the first expanded sheet, so as to create a corrugated plate whose final apparent thickness is 8 millimeters. The second sheet has a volume void rate of 95%. Finally, the structured support is prepared by inserting the second sheet between two expanded sheets similar to the first sheet. This structured support, composed by the assembly of three sheets, has a total thickness of 16 mm and a void rate of 92%.

Preferably, if the openings formed in the expanded sheets are not perfectly symmetrical, care will be taken to rotate the interposed sheet by an angle of 90° relative to the orientation of the two other sheets. In other words, the orientation of the meshes of the sheet placed in the center is rotated by 90° relative to the orientation of the meshes of the sheets placed on the outside. For example, if the meshes of the two external sheets have their great width horizontally, then the interposed sheet metal is oriented so that its meshes are positioned with their great width in the vertical direction.

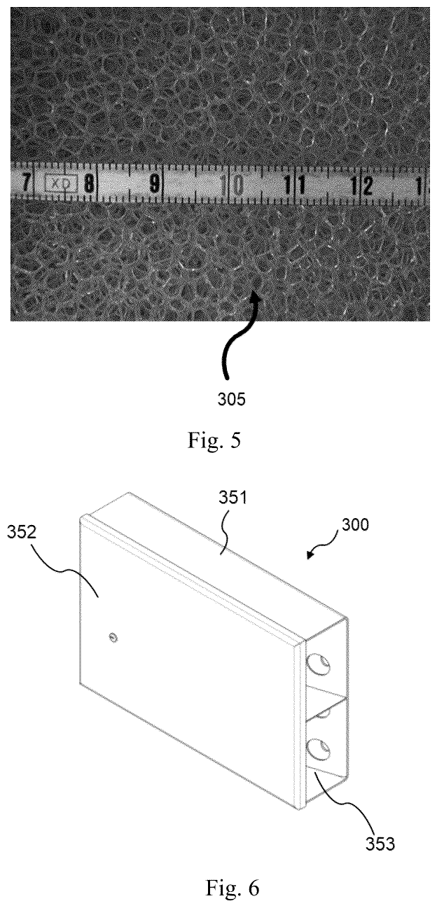

In FIG. 5 is shown a photograph of a structured support 305 which can be implemented in a particular embodiment of the invention. The structured support 305 is a cellular foam whose cells are open and whose size is comprised between 2 and 10 mm. These alveolar structures are flexible and formed from polyurethane.

It should be noted that the scale visible in the photograph in FIG. 5 is expressed in centimeters.

In other embodiments, the structured support may comprise a rigid cellular foam, for example made of metal or ceramic based on alumina or a mixture of metal oxides.

In embodiments (not illustrated), the structured support comprises a honeycomb structure formed by polygonal cells, in particular rectangular or hexagonal. The diameter of the hexagonal cells could for example be comprised between 1 and 25 millimeters. Preferably, the cells are made of metallic material and in particular aluminum; aluminum is advantageous because it is inert, light and has good fire resistance. The thickness of the walls of the cells is for example less than 3 millimeters, preferably less than 1 millimeter.

In embodiments, the structured support comprises a honeycomb structure of the type described above but pierced with numerous holes passing through the side walls forming the cells. For example, a honeycomb-structured support can be obtained by welding together previously pierced and then corrugated sheets.

In FIG. 6 is shown a particular embodiment of a device 300 for capturing microparticles according to the invention. The device 300 comprises a box 351, for example made of steel or thermoformed plastic, housing a structured support according to the invention (not visible in FIG. 6). The box 351 has a rectangular and flattened section. The box 351 is intended to be fixed to a surface, for example on a wall. For example, FIG. 7 illustrates an installation of the device 300 on the vertical surface of a train platform, facing the rails, in an underground station. In embodiments, the box 351 comprises a removable front panel 352, for example fixed by means of screws at each corner of the panel, or by means of a hinge connection between the front panel 352 and the body of the box 351, or by fitting one edge of the front panel 352 onto the housing 351 and mechanical locking to the opposite edge of the panel. In another embodiment, the supports are introduced into the box through the side openings. In any event, device 300 includes preferably a means of access to the structured support housed in the box, so as to be able to carry out maintenance operations on the structured support; these maintenance operations will be described in greater detail below.

Preferably, the structured support is formed of one or more flat plates, that is to say they have a thickness significantly lower than their width and height dimensions. Each plate is arranged in the box so that their plane forms an angle of 5 to 90° with the plane of the box, preferably between 1° and 45°. A box can house a structured support made up of several flat plates, arranged for example in a V or W depending on the thickness available inside the box.

The device 300 for capturing microparticles includes ventilation openings allowing external air to circulate inside the box 351. For example, holes are drilled on the surface of the front plate 352, or even side vents 353 are provided. Any other configuration allowing easier circulation of ambient air flows towards the interior of the box can be implemented without deviating from the invention.

Preferably, the box 351 has a thickness of less than 40 cm, preferably less than 30 cm and very preferably less than 25 cm. This low thickness allows installation in restricted spaces, in particular under the nose of a platform.

In addition to the implementation illustrated in FIG. 7, other implementations of the device which is the object of the invention are advantageous. Other uses in a tunnel, particularly in an underground complex dedicated to public rail transport, include installation in areas intended for pedestrian passenger traffic, at the nose of a platform, at the mouth of a rail tunnel, in a railway tunnel in a braking zone, or in a railway tunnel in an acceleration zone. According to a particularly advantageous mode of implementation, the microparticle capture devices will be positioned in the braking zone of a train, that is to say along the platform in the station or less than 100 meters away, preferably less than 50 meters from the mouth of the station, on the side from which a train arrives during normal circulation.

In other embodiments, a device according to the invention is installed in a road tunnel, for example on the wall at a height of between approximately 20 cm and approximately 200 cm from the ground, knowing that this height corresponds to the heights of the highest concentration of particles due to the combination between their point of generation by the emission of exhaust gases, by the abrasion of wheels and brakes, and by the circulation of dust deposited on the road, and their dilution by air currents present in the environment.

In yet other embodiments, a device according to the invention is installed outdoors, for example in a public space with frequent pedestrian traffic and positioned not far from a road.

We now describe methods for capturing microparticles in suspension in the air with reference to FIG. 8 which shows a succession of steps of a particular embodiment of a method 1000 of using a device for capturing microparticles in suspension in the air.

The method 1000 comprises a step 1005 of providing a structured support according to the invention. Such a structured support can be of the type described above, with reference to FIGS. 1 to 5.

During a step 1010, the structured support is coated with a capture medium configured to capture microparticles in suspension in an air flow by contact.

The coating methods may vary depending on the properties of the capture medium used. It is recalled that this capture medium is chosen from: a vegetable oil, a mineral oil, a synthetic or semi-synthetic oil, a water-soluble lubricant, a silicone oil, an animal fat, alone or in a mixture.

For example, the coating step 1010 can be carried out by immersing a structured support in a bath of capture medium. The capture medium can be heated to lower its viscosity prior to the immersion operation. Alternatively, the coating step 1010 can be carried out by sprinkling the capture medium onto the structured support. Any other means allowing a layer of capture medium to be applied to the structured support can be implemented without deviating from the invention.

Preferably, the capture medium is a liquid material at room temperature. For example, the capture medium is liquid at a temperature between 15° C. and 25° C., preferably liquid at a temperature between 10° C. and 30° C. In this case, a step of draining the structured support after immersion or sprinkling can be carried out to evacuate the excess capture medium.

In the case where the support is a metal support made of anodizable metal (such as aluminum), this will preferably be anodized before the coating step 1010.

During a step 1015, the structured support is brought into contact with an air flow loaded with microparticles. It is recalled that the coated structured support is configured to be traversed by an air flow at a linear speed between 0.1 and 5 m/s without causing a pressure drop greater than 300 Pa or even 250 Pa. It is also recalled that the device which is the object of the invention does not require, for its proper functioning, active ventilation means allowing the forced circulation of the air flow loaded with microparticles. Thus, the ambient air flows are exploited so that the air flows loaded with microparticles to be captured come into contact with the capture medium coated on the structured support. During this stage, the capture medium gradually becomes loaded with microparticles which adhere to the capture medium and/or partly penetrate into the medium.

It should be noted that the expression “active means of ventilation” as used here is limited to the device according to the invention, but does not include possible machines or mechanical devices generating a current of air, such as a train or a vehicle, or possible fans which provide a current of air in a tunnel: such a current of air, even generated by a machine or device external to the device according to the invention, is included here in the expression “ambient air flow”.

At the end of step 1015, preferably when the saturation of the capture medium reaches a level which lowers the capture performance of the medium too much, said medium is replaced. In a particular embodiment, the structured support as a whole is removed from the capture device which is the subject of the invention and discarded. Preferably, the capture medium is stripped of the capture support and the support is used again.

In the latter case, during a stripping step 1020, at least part of the medium coated on the structured support is removed. The methods of the stripping step 1020 are selected according to the nature of the capture medium, so as to maximize the proportion of capture medium stripped from the structured support and to minimize the degradation of the support.

In embodiments, the stripping step 1020 comprises washing the structured support coated with capture medium with water loaded with a detergent, for example with soapy water. This cleaning method will be particularly suitable for capture media soluble in soapy water. A jet of water is projected onto the structured support to release and cause the capture medium to flow. The water jet can be under high pressure and the water can be heated, depending on needs.

In embodiments, the stripping step 1020 comprises stripping the structured support coated with medium by a flow of pressurized air.

In embodiments, the stripping step 1020 comprises stripping the structured support coated with capture medium by a flow of pressurized steam. For example, the steam flow has a pressure of 4 bars and a temperature comprised between 150° C. and 180° C.

In embodiments, the stripping step 1020 includes cryogenic cleaning. Cryogenic cleaning is a process similar to sandblasting, but the media used is solid CO2 or dry ice. Dry ice is projected onto the surfaces to be cleaned in a stream of compressed air.

It is specified that several methods mentioned above for the counting step 1020 can be combined without deviating from the invention.

Once the structured support has been exposed during step 1020, a replacement step 1025 of the stripped capture medium is implemented. During the replacement step 1025, the structured support is coated again with a fresh capture medium, that is to say only lightly loaded with microparticles. The coating during step 1025 is preferably identical to that already described for step 1010 of initial coating of the structured support.

In embodiments, at the end of the stripping step 1020, the used capture medium loaded with microparticles is treated in order to reduce its microparticle content. For example, a filtration method is implemented or a centrifugation method, so as to obtain a fraction of recycled capture medium whose microparticle content is lower than that of the used capture medium. Thus, the “fresh” capture medium mentioned in the present application can refer to both a new capture medium and a recycled capture medium.

It is specified at this stage that the steps 1020 of stripping the saturated capture medium and 1025 of replacing the medium by coating the structured support with a fresh medium can be carried out on site, at the location where the device which is the object of the procedure is installed, or in a workshop, or in a factory. In the first case, a mobile workshop will for example be installed on a train wagon or on a mobile service vehicle (for example a van) so that these steps can be carried out on site. In the case where steps 1020 and 1025 are carried out in a workshop or factory, workers will remove the “used” structured supports and install new (or recycled) ones. The structured supports will then be brought back to the workshop or factory for recycling by implementing steps 1020 and 1025.

Microparticle capture performance tests carried out by the applicant on particular embodiments of the microparticle capture device according to the invention will now be described. Several particular embodiments of a device according to the invention are prepared, they are numbered 1 to 15 below.

Device for capturing microparticles no I (Olive oil/Aerosleep®): a woven support is provided in sheets of 0.045 m2 surface area and 6 mm thickness formed by 3D weaving of polyester fibers such as the Aerosleep product marketed by the company QLEVR. The weaving consists of two parallel faces comprising meshes of 5 mm opening (average size) representing approximately 63% of the surface. The density of the woven backing is 380 g/m2. It has a void rate of around 95%. The support is immersed in an olive oil bath preheated to 60° C. so that its entire surface is covered with oil. The coated support is removed from the bath, then hung vertically for 5 hours so that excess oil drips off naturally. The structured support coated with capture medium thus obtained has a density of 590 g/m2. Its void rate is close to 91%. It is emphasized that, to carry out the tests described in the rest of the text, a sufficient number of sheets of structured oil-coated support was prepared according to the specifications mentioned above to carry out each of the tests carried out with device no. 1.

Device no. 2 (Sunflower oil/Aerosleep®): device no. 1 was reproduced by replacing the olive oil with sunflower oil.

Device no. 3 (Peanut oil/Aerosleep®): device no. 1 was reproduced by replacing the olive oil with peanut oil.

Device no. 4 (Lard/Aerosleep®): device no. 1 was reproduced by replacing the olive oil with lard previously heated to 80° C. The lard thus deposited represents approximately 60% of the final mass of the structured support coated with capture medium.

Device no. 5 (Castor oil/Aerosleep®): device no. 1 was reproduced by replacing the olive oil with castor oil.

Device no 6 (Olive oil/PU foam 8 ppi): device no I was reproduced by replacing the woven support with an open cell polyurethane foam of 8 ppi and 3 cm thick (reference RegiCell 8 FM2 marketed by the company Foampartner). This support has a density of 27 kg/m3. The diameter of the open cells is approximately 4.5 mm. The void ratio calculated from the intrinsic density of the polyurethane (typically 1200 kg/m2) is approximately 98%. It decreases to 97% after coating the oil.

Device no. 7 (Peanut oil/PU foam 8 ppi): device no. 6 was reproduced by replacing the olive oil with peanut oil.

For each of devices No. 1 to 7, the structured support coated with a capture medium, described above, is housed in a box.

Device no. 8 (Olive oil/Aerosleep®): device no. 1 was reproduced in every detail. The final device has a density of 615 g/m2, i.e. a capture medium loading rate of 235 g/m2.

Device no. 9 (Sunflower oil/Aerosleep®): device no. 2 was reproduced in every detail. The final device has a density of 621 g/m2, i.e. a capture medium loading rate of 241 g/m2.

Device no. 10 (Sweet almond oil/Aerosleep®): device no. 1 was reproduced by replacing the olive oil with sweet almond oil. The final device has a density of 593 g/m2, i.e. a capture medium loading rate of 213 g/m2.

Device no II (Water-soluble lubricant 1/Aerosleep®): device no I was reproduced by replacing the olive oil with the water-soluble lubricant Solester 530 marketed by the company Molydal.

The final device has a density of 536 g/m2, i.e. a capture medium loading rate of 156 g/m2.

Device no. 12 (Water-soluble lubricant 2/Aerosleep®): device no. 1 was reproduced by replacing the olive oil with the water-soluble lubricant Solester 540 marketed by the company Molydal.

The final device has a density of 682 g/m2, i.e. a capture medium loading rate of 302 g/m2.

Device no. 13 (2 layers of olive oil/Aerosleep®): two devices identical to device no. 1 were reproduced and superimposed, spacing them 1 mm apart.

Device no. 14 (4 layers of olive oil/Aerosleep®): four devices identical to device no. 1 were reproduced and superimposed, spacing them 20 mm apart.

Device no. 15 (6 layers of olive oil/Aerosleep®): six devices identical to device no. 1 were reproduced and superimposed, spacing them 20 mm apart.

During a first test (test 1), the applicant carried out an evaluation of the performance of capturing microparticles by devices according to the invention in an underground passenger rail transport network, in a tunnel.

Test 1: devices 1 to 7 detailed above are exposed to the air of a tunnel in an underground passenger rail transport network, approximately 15 meters from the entrance to an underground station. The average content of fine PM10 particles in the station was previously measured at 93 μg/m3, and the speed of passage of polluted air through the boxes was measured at 0.14 m/s on a daily average. The box housing the structured support coated with capture medium is fixed to the tunnel wall, approximately 1.5 meters from the nearest rail. The bottom of the box is 20 cm from the ground. The structure of the box similar to that illustrated in FIG. 6. It has two opposite open faces, positioned perpendicular to the tunnel wall so that the air flow generated by the passage of trains can pass through it. Inside the box, several structured supports coated with capture medium form an angle of 15 degrees with the tunnel wall.

After exposure, the structured supports coated with capture medium are removed then washed by holding them for 15 minutes in agitated soapy water heated to 80° C. so as to remove the fine particles which have been trapped. The washing water is then filtered through a cellulose membrane with openings of 0.45 μm. The filtered particles and the membrane are rinsed with ethanol to remove oil residues. The quantity of PM collected is determined by weighing the membrane, after drying at 60° C. for 2 hours.

The results obtained are grouped in Table 1 for different structured supports coated with capture medium and for different exposure times. They are expressed in grams (g) of solid particles (PM) collected on the structured support coated with capture medium per day and per square meter of structured support coated with capture medium (gPM/m2/d), on average over the exposure period.

TABLE 1

| | | Duration of | Particules |
|---|---|---|---|
| | Device | exposure | captured |
| Reference | tested | (in days) | (gPM/m²/d) |
| Test1-a | Device 1 | 14 | 0.35 |
| Test1-b | Device 1 | 17 | 0.61 |
| Test1-c | Device 1 | 17 | 1.01 |
| Test1-d | Device 1 | 25 | 0.38 |
| Test1-e | Device 1 | 42 | 0.47 |
| Test1-f | Device 1 | 56 | 0.57 |
| Test1-g | Device 2 | 11 | 0.18 |
| Test1-h | Device 2 | 17 | 0.37 |
| Test1-i | Device 3 | 14 | 0.92 |
| Test1-j | Device 3 | 14 | 0.51 |
| Test1-k | Device 3 | 17 | 0.75 |
| Test1-l | Device 3 | 28 | 0.25 |
| Test1-m | Device 3 | 28 | 0.44 |
| Test1-n | Device 3 | 42 | 0.10 |
| Test1-o | Device 4 | 17 | 0.86 |
| Test1-p | Device 5 | 11 | 0.28 |
| Test1-q | Device 5 | 11 | 0.24 |
| Test1-r | Device 5 | 14 | 0.25 |
| Test1-s | Device 6 | 14 | 0.52 |
| Test1-t | Device 7 | 14 | 0.41 |

The devices tested show good capture performance in ambient air in an underground partitioned environment. It is noted a quantity of particles captured between 0.18 gPM/m²/d and 1.01 gPM/m²/d depending on the tests, with an average of around 0.47 gPM/m²/d. It is noted that a longer duration of exposure, up to 56 days, does not seem to significantly reduce the average quantity of particles captured.

The particle size analyzes of suspended particles carried out on the washing water of the tests referenced TestI-b and TestI-c in Table 1 (reproduction tests) indicate, in both cases, a volume fraction of PM10, PM2.5 and PM1 of 48%, 19% and 4% respectively.

During a second test (Test 2), the applicant carried out an evaluation of the capture performance of microparticles by devices having undergone stripping of a used capture medium followed by a new coating with a new medium. These reused devices are tested in an underground passenger rail transport network.

Test 2: The structured supports coated with capture medium from the tests referenced TestI-b and TestI-k in the table above are recycled by re-coating with oil, respectively under the same conditions as those described for devices no. I and no 3 above. The devices obtained after re-coating are exposed again under the same conditions as for test 1. Table No. 2 compares the results obtained for structured supports coated with new capture medium (referenced TestI-b and TestI-k above) and for structured supports coated with capture medium recycled once and twice.

TABLE 2

| | | Duration of | Particules |
|---|---|---|---|
| | | exposure | captured |
| Reference | Device tested | (in days) | (gPM/m²/d) |
| Test1-b | Device 1 | 17 | 0.61 |
| Test2-a | Device 1 | 14 | 0.38 |
| | recycled once | | |
| Test2-b | Device 1 | 14 | 0.73 |
| | Recycled twice | | |
| Test1-k | Device 3 | 17 | 0.75 |
| Test2-c | Device 3 | 14 | 0.41 |
| | Recycled once | | |
| Test2-d | Device 3 | 14 | 0.81 |
| | Recycled twice | | |

It is noted that the structured supports recycled and coated again (Test2-a, b, c and d) capture a comparable quantity, that is to say of the same order of magnitude, of particles as the new supports coated with new medium of capture (TestI-b and k).

During a third test (Test 3), the applicant carried out an evaluation of the performance of capturing microparticles by devices according to the invention in an underground passenger rail transport network, at the level of a platform in a station.

Test 3: the conditions of test 1 were reproduced but by placing the box containing the structured supports coated with capture medium in a station, under a platform nose. The bottom of the box is at ballast level, in the middle of the station, and its distance from the nearest rail is 0.8 meters. On a daily average, the air speed through the box was measured at 0.31 m/s. The results for this location are given in table no. 3 for different structured supports coated with capture medium and exposure times.

TABLE 3

| | | Duration of | Particules |
|---|---|---|---|
| | | exposure | captured |
| Reference | tested | (in days) | (gPM/m²/d) |
| Test3-a | Device 1 | 14 | 0.32 |
| Test3-b | Device 1 | 14 | 0.35 |
| Test3-c | Device 1 | 28 | 0.41 |
| Test3-d | Device 1 | 47 | 0.23 |
| Test3-e | Device 1 | 14 | 0.21 |
| Test3-f | Device 6 | 14 | 0.38 |
| Test3-g | Device 6 | 14 | 0.52 |

It is noted that the supports placed under a platform nose (Test3-a to g) capture a comparable quantity, that is to say of the same order of magnitude, of particles as the supports placed in a tunnel (TestI-a to f and s).

During a fourth test (Test 4), the applicant carried out an evaluation of the performance of capturing microparticles by devices according to the invention in an underground passenger rail transport network, at the level of a corridor allowing foot traffic of passengers.

Test 4: the conditions of the first test are reproduced but by placing the box containing the structured supports coated with capture medium on the wall of a passenger corridor opening onto the station platform at a height of approximately 1.5 meters from the ground. On a daily average, the air speed through the box was measured at 0.43 m/s. The results for this location are given in table no. 4 for different devices and exposure times.

TABLE 4

| | | Duration of | Particules |
|---|---|---|---|
| | Device | exposure | captured |
| Reference | tested | (in days) | (gPM/m²/d) |
| Test4-a | Device 1 | 17 | 0.12 |
| Test4-b | Device 1 | 25 | 0.17 |
| Test4-c | Device 1 | 42 | 0.28 |
| Test4-d | Device 1 | 56 | 0.10 |
| Test4-e | Device 1 | 14 | 0.29 |
| Test4-f | Device 3 | 14 | 0.22 |
| Test4-g | Device 3 | 28 | 0.21 |

It is noted that the supports placed in a corridor for passengers (Test 4) capture a comparable quantity, that is to say of the same order of magnitude, of particles as the supports placed in a tunnel (Test 1) or under the nose of the platform (Test 3). However, the quantity of particles captured by the supports placed in a corridor for passengers (Test 4) is significantly lower.

During a fifth test (Test 5), the applicant carried out an evaluation of the performance of capturing microparticles by devices according to the invention near a road traffic axis.

Test 5: The structured supports coated with capture medium are hung on a mesh protected from rain and exposed directly to the outside air near a busy intersection. The quantities of microparticles collected over the exposure period are determined by washing as in test no. 1. The results are given in table no. 5.

TABLE 5

| | | Duration of | Particules |
|---|---|---|---|
| | Device | exposure | captured |
| Reference | tested | (in days) | (gPM/m²/d) |
| Test5-a | Device 1 | 7 | 0.83 |
| Test5-b | Device 1 | 14 | 1.14 |
| Test5-c | Device 1 | 21 | 098 |
| Test5-d | Device 1 | 28 | 0.71 |
| Test5-e | Device 2 | 3 | 0.74 |
| Test5-f | Device 2 | 6 | 0.75 |
| Test5-g | Device 2 | 7 | 0.86 |
| Test5-h | Device 2 | 14 | 1.44 |
| Test5-i | Device 2 | 18 | 0.48 |
| Test5-j | Device 2 | 77 | 0.43 |

The tested devices show good ambient air capture performance in an open-air environment. It is noted a quantity of particles captured between 0.43 gPM/m²/d and 1.44 gPM/m²/d depending on the tests, with an average of around 0.84 gPM/m²/d.

The particle size analysis of the particles suspended in the washing water of Example No. 5a indicates that the PM 10, PM2.5 and PM1 particles represent respective volume fractions of 62%, 23% and 9%.

Test 6: Devices No. 8 to 12 are used to compare the ease of washing the media depending on the nature of the capture medium. Devices No. 8 to 10 are washed by soaking in water at 70° C. containing a surfactant, under ultrasound for 15 minutes. The media is then removed from the washing bath, rinsed with water, dried for 2 hours at 60° C. then weighed.

Devices No. 11 and 12 are washed by soaking in water at room temperature, without surfactant, under ultrasound for 15 minutes.

The media is then removed from the washing bath, rinsed with water, dried for 2 hours at 60° C. then weighed.

For each device, the washing rate of the capture medium is calculated. The washing rate, without units and expressed in percentages, is calculated as follows:

$$Washing rate ( \% ) = 1 - \frac{{T}_{i} - {T}_{f}}{{T}_{i}} \qquad Math 1$$

Where Tᵢ is the initial load expressed in grams per square meter (g/m²). Tᵢ is obtained by subtracting the density of the support alone (in g/m²) from the density of the coated support (in g/m²).

Where T_{f} is the final load (in g/m2). T_{f} is obtained by subtracting the density of the support alone (in g/m2) from the density of the coated and then washed support (in g/m2).

A high washing rate, closer to 100%, indicates that significant recovery of the capture medium is possible by washing. On the contrary, a low washing rate indicates less recovery of the capture medium.

The washing rates obtained are significantly higher for devices 11 and 12, compared to the washing rates of devices 8 to 10, despite the absence of heating of the washing water and the absence of surfactant.

These results show that better recovery of the capture medium is obtained when the capture medium is a water-soluble lubricant (tests 6-d and 6-e), compared to lower recovery when the capture medium is a vegetable oil (tests 6-a to 6-c).

TABLE 6

| | | Duration of | Washing |
|---|---|---|---|
| | Device | exposure | rate |
| Reference | tested | (g/m²) | (%) |
| Test6-a | Device 8 | 235 | 69 |
| Test6-b | Device 9 | 241 | 65 |
| Test6-c | Device 10 | 213 | 68 |
| Test6-d | Device 11 | 156 | 95 |
| Test6-e | Device 12 | 302 | 96 |

Test 7: The structured supports coated with capture medium are positioned on the edge of a busy urban boulevard, in a box protecting them from the rain. The quantities of microparticles collected over the exposure period are determined by washing as in test no. 1. The results are given in table no. 7.

It is emphasized that tests 7a and 7b were carried out during a first period, that tests 7c and 7d were carried out during a second period distinct from the first, and that tests 7e, 7f and 7g were carried out during of a third period, on dates different from the first two tests. Thus, the differences in particles captured between test 7a and test 7e, both carried out over a period of 14 days of exposure and with device 1, can be explained by the differences in conditions (particle concentration in the air, weather conditions) during these tests.

For tests 7-b and 7-d, the masses of particles captured on each of the two layers of device no. 13 are respectively 2.89 g/m²/d and 2.03 g/m²/d for test 7-b and 1.63 g/m²/d and 4.11 g/m²/d for test 7-d. For test 7-f, the masses of particles captured on each of the four layers of device no. 14 were respectively 1.99 g/m²/d, 1.58 g/m²/d, 1.31 g/m²/d and 1.72 g/m²/d. For the 7-g test, the masses of particles captured on each of the four layers of device no. 15 were respectively 2.10 g/m²/d, 1.93 g/m²/d, 1.61 g/m²/d, 1.17 g/m²/d, 1.25 g/m²/d, and 1.49 g/m²/d.

The particle size analyzes of the particles suspended in the washing water of layers no. 1 and no. 2 of device 14 of example no. 7f indicate that the PM10, PM2.5, and PM1 particles represent respective volume fractions of 82%, 29%, and 8% for the first layer and 89%, 52%, and 16% for the second layer.

The particle size analyzes of the particles suspended in the washing water of layers no. 1 and no. 3 of device 15 of example no. 7g indicate that the PM10, PM2.5, and PM1 particles represent respective volume fractions of 94%, 59%, and 15% for the first layer and 99%, 54%, and 13% for the third layer.

TABLE 7

| | | Duration of | Particules |
|---|---|---|---|
| | Device | exposure | captured |
| Reference | tested | (in days) | (gPM/m²/d) |
| Test7-a | Device 1 | 14 | 3.28 |
| Test7-b | Device 13 | 14 | 5.73 |
| Test7-c | Device 1 | 28 | 1.89 |
| Test7-d | Device 13 | 28 | 4.92 |
| Test7-e | Device 1 | 14 | 4.53 |
| Test7-f | Device 14 | 14 | 6.60 |
| Test7-g | Device 15 | 14 | 9.54 |

Test 8: During test 8, the pressure drop of the structured supports coated with capture medium was measured as a function of the air speed passing through them for devices 1, 13, 14, and 15. For each of these tests a structured support as described for devices 1, 13, 14, and 15 is cut into a disk of 40 mm in diameter then coated with a capture medium as detailed above in the description of devices 1, 13, 14, and 15. The structured support coated with capture medium is placed in a tube of the same diameter (40 mm), equipped with a differential pressure sensor between upstream and downstream of the disk. A variable air pressure is applied to the inlet of the tube and the speed of passage of the air through the device is measured using an anemometer placed upstream of the disk. The pressure drop generated by the disk for each air speed is recorded. It is verified that the pressure drop is proportional to the square of the air speed.

By linear regression, the pressure drop generated by the device for an air speed of 5 meters per second is calculated.

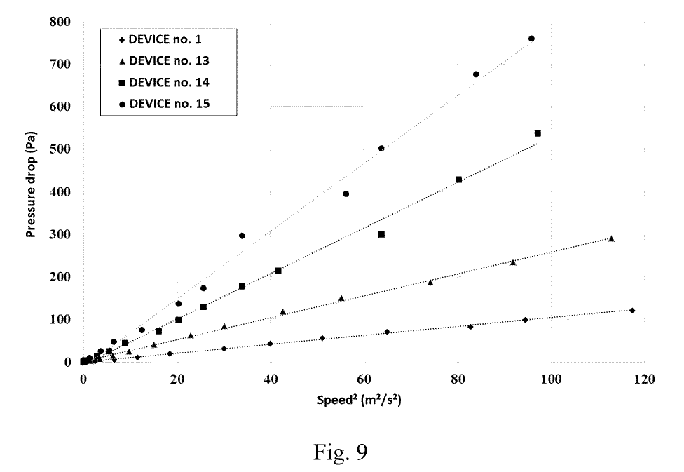

The results are reported in FIG. 9 as a function of the square of the air speed.

For an air speed of 5 meters per second, the pressure drop of these devices is respectively 26 Pa, 65 Pa, 127 Pa and 189 Pa.

It is recalled that, according to the invention, the structured support coated with said capture medium is configured to be traversed by an air flow at a linear speed comprised between 0.1 m/s and 5 m/s without causing a pressure drop greater than 300 Pa, preferably without causing a pressure drop greater than 250 Pa.

Translation of FIG. 8:
1005: Providing a structured support
1010: Coating of a structured support by a capture medium
1015: Bringing the structured support into contact with an air flow loaded with microparticles
1020: Stripping of at least part of the medium coated on the structured support
1025: Replacing the stripped capture support by coating with a fresh capture medium
Translation of FIG. 9:
Horizontal axis: speed² [m²/s²]
Vertical axis: pressure drop [Pa]
Box: Device no 1, Device no 13, Device no 14, Device no 15

1-25. (canceled)

26. A device for capturing microparticles in suspension in air, the device comprising:
a structured support traversed by a plurality of openings having a minimum dimension of between 1 millimeter and 15 mm, the structured support having a void ratio greater of than 90%, the structured support having a coating comprising a capture medium for capturing microparticles in suspension in an air flow, wherein the capture medium is chosen from vegetable oils, mineral oils, synthetic oils, semi-synthetic oils, water-soluble lubricants, silicone oils, animal fats, alone or a mixture thereof, wherein the capture medium is configured to be traversed by an air flow at linear speed of between 0.1 and 5 m/s without causing a pressure drop greater than 250 Pa,
wherein the device has no active manner of ventilation and no electrical energy supply.

27. The device of claim 26, wherein the structured support is formed in a non-porous material.

28. The device of claim 26, wherein:
the structured support is arranged substantially vertically, and
the capture medium comprises a liquid material which at room temperature is maintained on the structured support by surface tension.

29. The device of claim 26, wherein:
the capture medium comprises a vegetable oil chosen from olive oil, apricot oil, jojoba oil, sweet almond oil, castor oil, coconut oil, shea oil, hazelnut oil, plum oil, sea buckthorn oil, argan oil, avocado oil, hemp oil, macadamia oil, oleic sunflower oil, or palm oil, or
the capture medium is chosen from silicone and paraffin oils, or
the capture medium is chosen from water-soluble polyester-based lubricants.

30. The device of claim 26, wherein the capture medium comprises a vegetable oil chosen from compositions containing few unsaturated and polyunsaturated fatty acids or containing a high antioxidant content, which give them good stability over time.

31. The device of claim 26, wherein the capture medium comprises a vegetable oil comprising an added antioxidant compound.

32. The device of claim 26, wherein the capture medium comprises a silicone oil chosen from pure polydimethylsiloxanes or polydimethylsiloxanes modified by poly ethers.

33. The device of claim 26, wherein the structured support comprises a textile woven from polyester fibers.

34. The device of claim 26, wherein:
the structured support comprises a cellular foam having open cells with a size of between 2 and 10 mm,
the structured support is chosen from a polyurethane foam and a metal or ceramic foam based on alumina or a mixture of metal oxides.

35. The device of claim 26, wherein the structured support comprises an anodized metallic structure.

36. The device of claim 35, wherein the structured support is an assembly of a plurality of metal plates that includes a metal plate of an expanded metal corrugated by stamping, the metal plate being interposed between two metal plates of an expanded metal.

37. The device of claim 35, wherein the structured support comprises a metallic honeycomb structure forming a pattern of polygonal cells.

38. The device of claim 35, wherein the structured support comprises a plurality of layers superimposed and spaced apart from each other by a distance of at least 5 mm.

39. Use of the device of claim 26 in an underground tunnel of a rail station for collective rail transport in areas of pedestrian passenger traffic, at a nose of a quay, at a mouth of a railway tunnel, in a railway tunnel in a braking zone, or in a railway tunnel in an acceleration zone.

40. The use of claim 39, wherein the device is positioned:
at an end region of the underground tunnel before arrival at the rail station,
in close proximity to an outer rail and opposite a braking system of a train when the train enters the rail station, and
at a height corresponding to a height of the braking system.

41. A method for capturing microparticles in suspension in air, the method comprising:
providing a structured support traversed by a plurality of openings having a minimum dimension of between 1 millimeter and 15 mm, the structured support having a void ratio greater of than 90%;
coating the structured support with a coating comprising a capture medium for capturing microparticles in suspension in an air flow, wherein the capture medium is chosen from vegetable oils, mineral oils, synthetic oils, semi-synthetic oils, water-soluble lubricants, silicone oils, animal fats, alone or a mixture thereof, wherein the capture medium is configured to be traversed by an air flow at linear speed of between 0.1 and 5 m/s without causing a pressure drop greater than 250 Pa; and
bringing the structured support into contact with the air flow loaded with microparticles without active ventilation, thereby allowing forced circulation of the air flow loaded with microparticles.

42. The method of claim 41, further comprising:
stripping at least part of the capture medium coated on the structured support, and
replacing the stripped capture medium with a new coating of a second capture medium.

43. The method of claim 42, wherein the stripping is conducted using a flow of pressurized air or a flow of pressurized steam.

44. The method of claim 42, wherein the stripping comprises cryogenic cleaning.

45. The method of claim 42, wherein the coating of the structured support with a capture medium is carried out by dipping the structured support in the capture medium or sprinkling the capture medium onto the structured support.
